(19) United States
(12) Patent Application Publication
(10) Pub. No.: US 2005/0015710 A1
(43) Pub. Date: Jan. 20, 2005

(54) Family website system

(76) Inventor: Lori Beth Williams, Northfield, MN (US)

Correspondence Address: Law Office of Christopher G. Frank, Suite 2004, 111 Marquette Avenue South, Minneapolis, MN, 55401, US

(21) Appl. No.: 10/878,209

(22) Filed: Jun. 28, 2004

(30) Foreign Application Priority Data
Jul. 18, 2003 (DE) 103 32 637.5

(51) Int. Cl. G06F 15/00

(52) U.S. Cl. 715/500

(57) ABSTRACT

The present invention provides a family website system having a group webpage for displaying in a visually intuitive manner to various sub-group webpages of the family website system. A number of sub-group webpages may include more detailed information relating to a particular family unit and/or to provide specific services and information such as a calendar of family events, a message center, a family photograph album, medical statistics, words of wisdom, personal resumes and so on. Each member may create and display a personal webpage having multimedia information in a design and layout that fits the characteristics of the member. Any changes made to the various pages of the website may be indicated in a notification section on relevant webpages on the website, such as on a section of the group webpage. Each family member may create a personal homepage that is customizable to contain selected features of the family website system.

### BACKGROUND OF THE INVENTION

1. Field of the Invention

The present invention relates generally to the field of customizable web sites with interrelated web pages, and more particularly to a method and system for collecting, organizing and displaying multimedia information and communications relating to a family or other interrelated group of people.

2. Background of the Prior Art

The family is the social and support system around which most people's lives revolve. As time passes and a family grows, family members may find themselves miles and oceans apart from each other. This can affect the communication and sense of connectedness that is felt between family members.

Families often use photographs as a means of capturing events and experiences, such as of a new child being born, a wedding, or a family reunion. These photographs can act as a timeless memento and can be viewed at a later date, and shared with other family members, increasing the communication and connectedness of important family events.

With the advent of the internet and digital photography, it is now possible to send digital photographs via email to any number of friends and family members. Until recently, only the most technologically savvy were able to fully utilize these products and services. However, digital photography, email and the use of the internet have advanced to the point where they are easily adopted by mainstream audiences.

There now exists a number of service providers that allow individual users to upload digital photographs, videos and textual information to a personal web page. Users can then notify friends and family of the URL address of their webpage for viewing online.

A problem with these personal web pages is that they are not interconnected and/or interrelated with other web pages. For example, one family member may have her own personal web page but her web page will not be intuitively linked to the personal web pages of other family members. Therefore, a family member wishing to view the personal web page of more than one family member would have to maintain a collection of different URL addresses for each family member. This problem becomes even more pronounced when a user would like to view the personal web pages of extended family members outside of the immediate nuclear family.

Another problem is that many family members either do not maintain a personal web page or they do not regularly update their personal web page because of the hassle of notifying other family members every time that a new photograph is added and/or every time that a change is made to the personal web page. Even notifying other family members via email can involve a large amount of time in retrieving a large number of email addresses and typing an appropriate message, and documenting and entering the URL address of the personal web page to which the changes have been added.

Yet another problem, is that the prior art products and services lack an integrated website for containing integrated information relating to the various members of the group of family members and friends beyond the mere display of photos and captions. The present invention addresses these and additional shortcomings of the prior art, as discussed in the sections that follow.

### SUMMARY OF THE INVENTION

The present invention relates to a virtual family website system for allowing members of a family to have an integrated system for communicating and updating the activities of each other.

A group family page has a number of links to the various sections of the family website system, organized in a visually intuitive layout. Hyperlinks to additional sub-group webpages allow visitors to the group page to view more detailed information about a particular person in the family, and to view family related messages and information.

The website may have a number of sub-group pages. One such page is an interactive message center allowing family members to post and respond to messages via email or online. Additionally, an urgent message selection may be posted, such that it is also displayed on the group webpage.

Another sub-group page is a family calendar page which may include birthdays, holidays and family events such as upcoming reunions and weddings. Additionally, a host of links relating to internet websites not associated with the family website system may be linked to, such as stores with which a wedding couple is registered, or travel information for attending a family reunion, and so on. There may also be family website pages devoted to a particular event.

Another sub-group page may be a collection of various words of wisdom and related words of advice and/or humor from different family members.

Each individual family unit may have a specific sub-group page that is linked from the group page, and has further links to the personal pages of the individual members of that particular family unit. These pages may contain photos, multi-media, internet links and information relating to the person or persons to whom the pages relate.

A family tree page is another sub-group page. This page may be dynamically created to show the linkage of different family members with the visitor to the web page being the center of the tree, and lineage being illustrated backwards and forwards therefrom. Each member displayed may have information and/or photos and may link to a particular individuals personal page or other sub-group pages.

Another sub-group page is a family photo album page displaying any number of photos and captions of various family members. A number of such photo album pages may be interlinked for organizational purposes, such as in accordance with each family unit of the family tree.

All of these features are displayable on a webpage and viewable from a remote computer by accessing a server containing the family website system.

Another sub-group page of the present invention is a medical statistics page which contains information relating to the medical history of the various members of the family tree.

The family website system may be partially or wholly password protected such that only family members may view particular portions of the website. More particularly, different family members may have limited access to the administration of the family website. For example, a family member may be able to administrate a personal webpage but not have permission to make changes to the group page or any sub-group pages.

The family website system will allow for users to easily make changes to the various pages of the family website in accordance with the permissions that they have been granted. Each page of the family website is then capable of having a notification section in which a link and/or graphic is displayed linking to pages that have been recently changed. This allows for visitors, for example, to quickly find and view new photographs, personal pages and so on, and allows users to easily notify other family members of changes that have been made to their personal pages, and to display and send messages and information to other family members.

### BRIEF DESCRIPTION OF THE DRAWINGS

FIG. 1 illustrates a group home page

FIG. 2 illustrates a sub-group page

FIG. 3 illustrates an individual sub-group page

FIG. 4 illustrates a post office and message center sub-group page

FIG. 5 illustrates a family tree sub-group page

FIG. 6 illustrates a virtual family photo album and quotations sub-group page

FIG. 7 illustrates a family calendar and events sub-group page

FIG. 8 illustrates a family medical history sub-group page

FIG. 9 illustrates a system in accordance with the present invention

FIG. 10 illustrates an administrative page

FIG. 11 illustrates a homepage

### DETAILED DESCRIPTION OF THE PREFERRED EMBODIMENTS

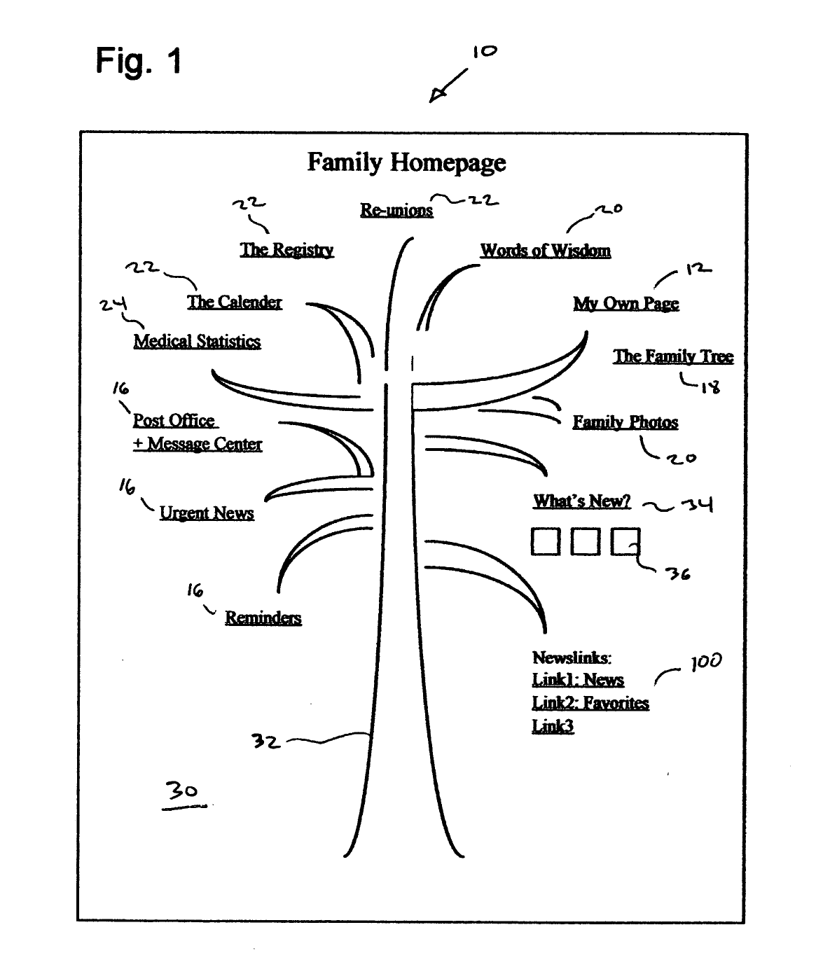

FIGS. 1-8 show various interrelated components of a family website system organized in accordance with one or more embodiments of the present invention. In order to fully describe the present invention, a number of terms must first be defined herein.

A “webpage” or “page” is a single URL address viewable over the internet by an internet browser.

A “website” includes all of the interlinked webpages that are contained within the administration of the users of the family website system.

A “visitor” is a person that is able to view a webpage and/or website.

A “link” or “hyperlink” is a link from one webpage to another webpage such that a visitor is then able to view the linked to website.

A “user” is a person that is able to administrate at least a portion of the family website system.

A “family member” is not limited to blood descent, but may include any person that is included within the groups defined by the users of the family website system.

A “family tree” is a visually intuitive display of the various family members and may have any number of branches and connections between ancestors and descendants and so on.

A “founder” is the person that registers for use and access to the family website system for uploading of family information.

An “administrator” is any user of the family website system that makes changes, additions and/or deletions to the website.

A “group page” refers to the main homepage for the family website system, the parent webpage shown in FIG. 1.

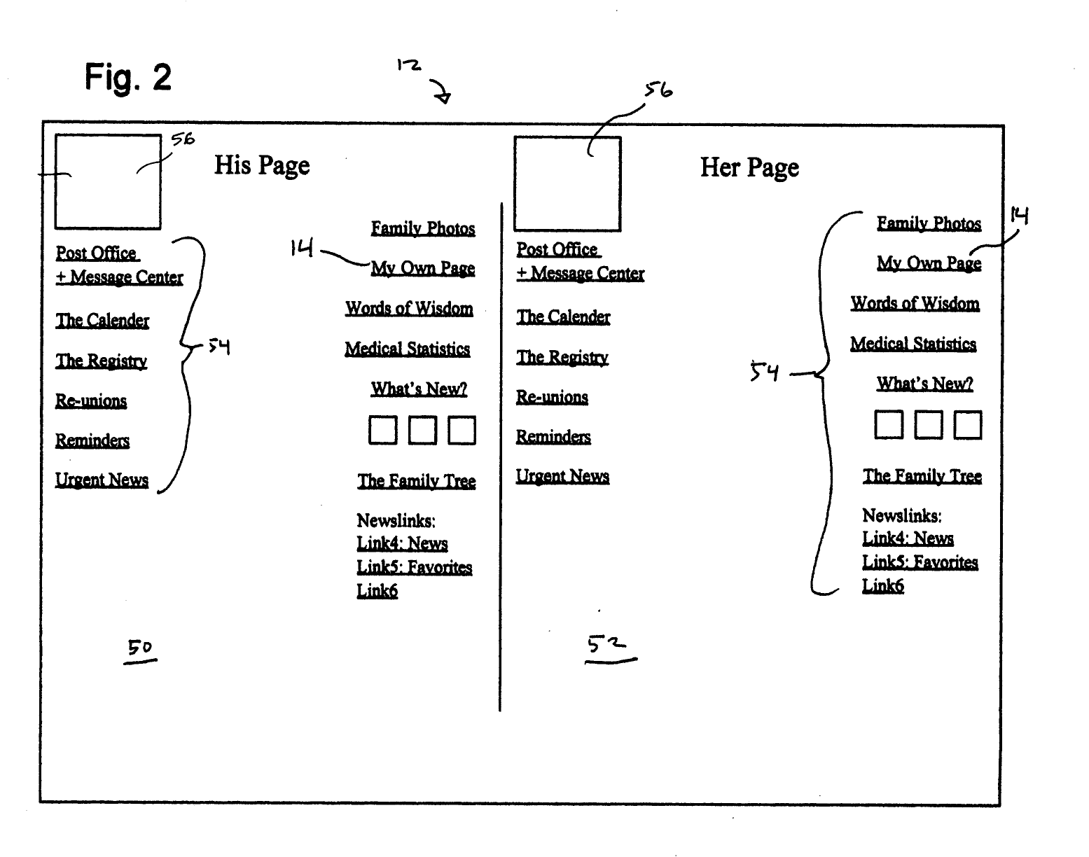

A “sub-group page” is a child webpage from the group page. For example, the group page may contain links to various sub-group pages, such as to the various families of the siblings of a family, as shown in FIG. 2 and FIGS. 4-8.

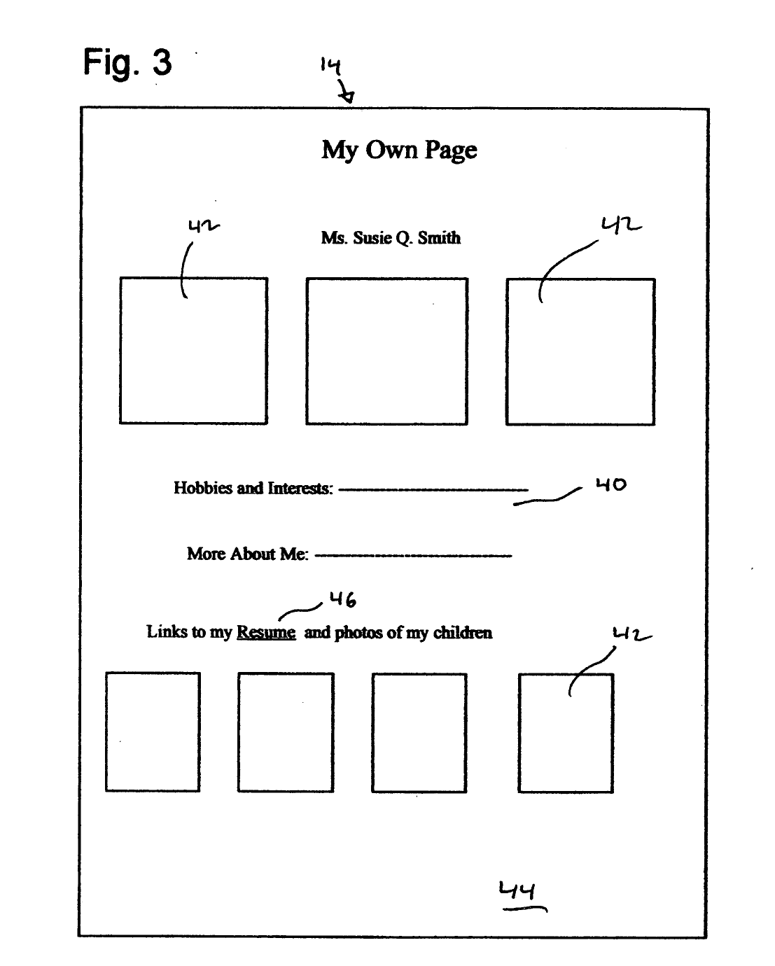

A “personal page” is a grandchild webpage with respect to the group page. For example, the individual members of the sub-group, such as a family of a sibling, may each have their own personal page, as shown in FIG. 3.

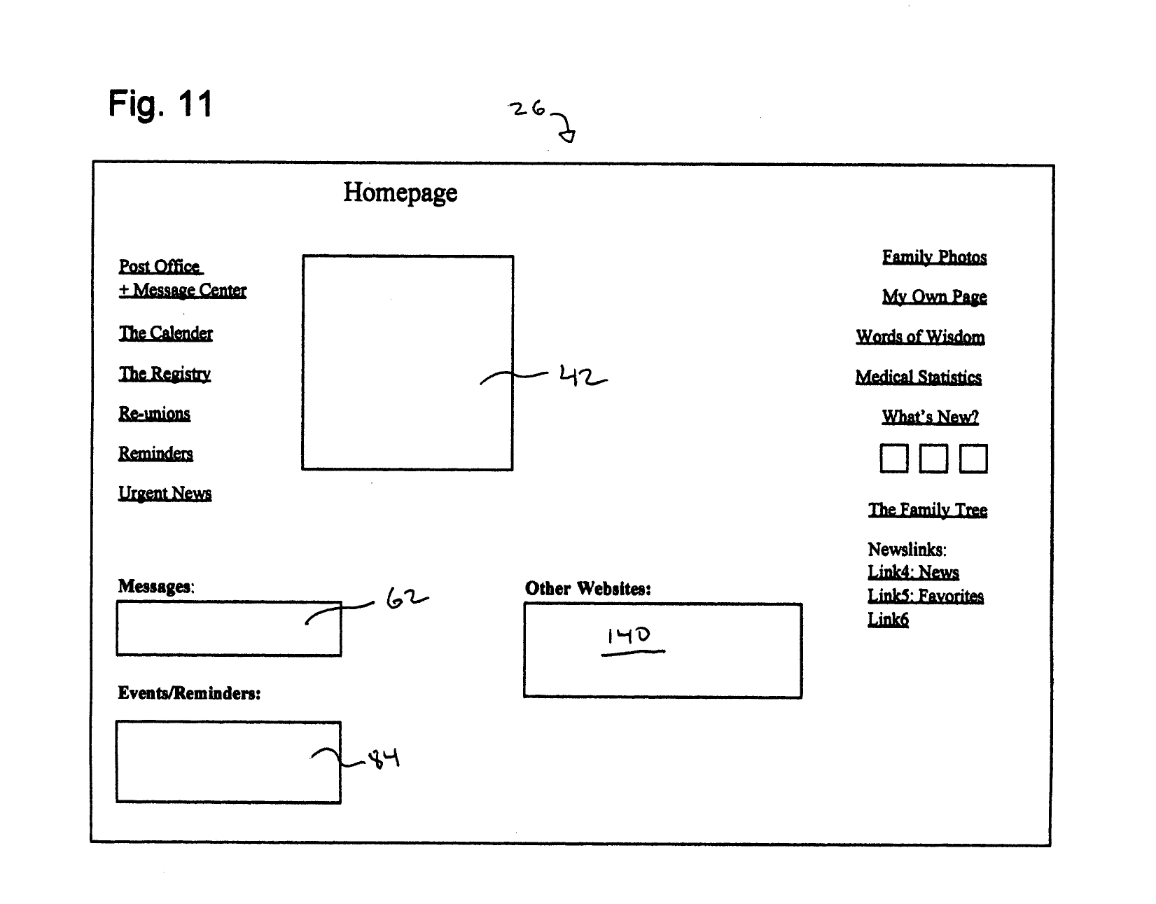

A “homepage” may refer to the main group webpage but may also refer to a customizable page that a user can modify to view various components of the website. The homepage may also be demarcated on a user's internet browser such that it is the page that is downloaded upon opening the web browser. The homepage may incorporate any combination of features described with respect to FIGS. 1-8, an example of which is shown in FIG. 11.

“Password protection” means that a particular web page or pages cannot be accessed until a visitor or user has entered a predetermined password.

“Multimedia” includes textual files and information, video files and information, audio files and information, digital photographs and any other such information and files displayable, downloadable or accessible over the internet.

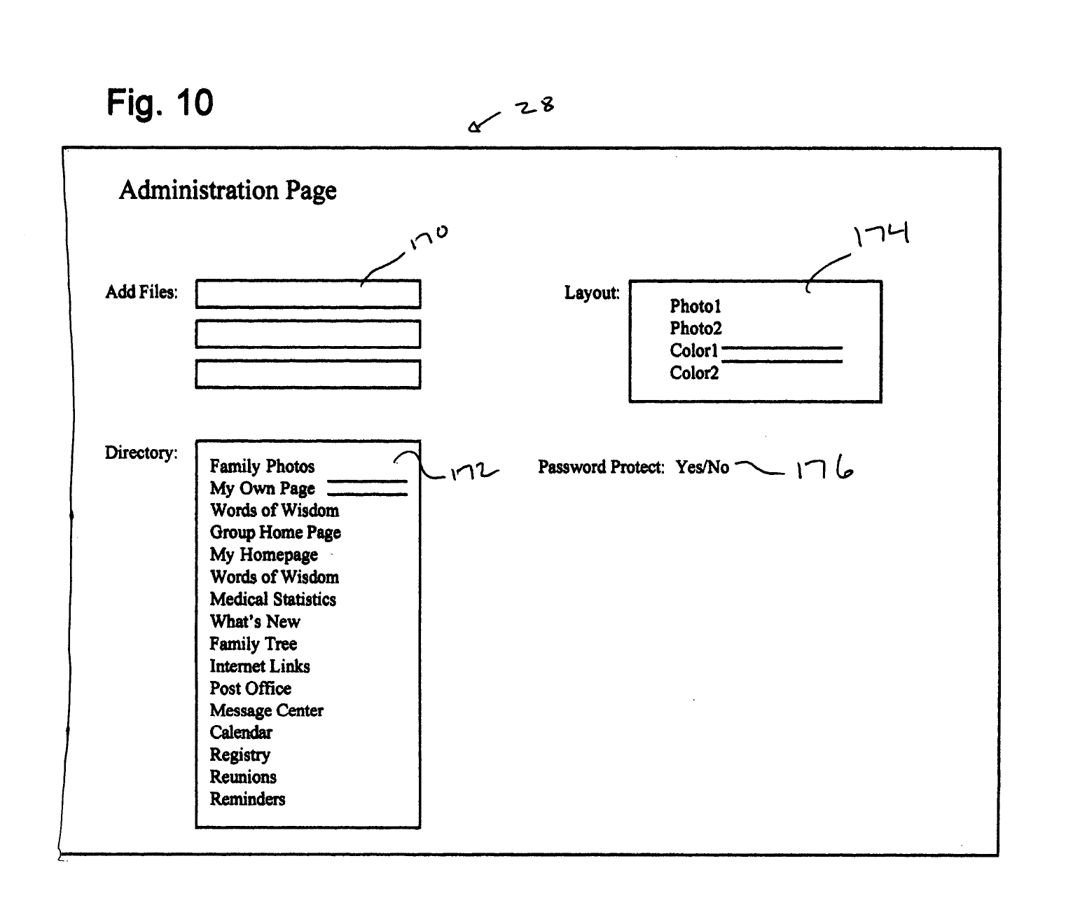

An “administrative page” is any page that allows a user to modify various portions of the family website system, such as by adding multimedia files and so on. This may include adding events to a family calendar and/or posts to a family message center. A number of different administrative pages may be utilized, for example, one for each webpage in the website. An example of an administrative page is shown in FIG. 10.

Any other terms and definitions shall be defined, as necessary, in the context of the following detailed description.

The present invention is a customizable and modifiable website. The following features are intended to be available for use wholly or partially in accordance with the use of the present invention.

FIG. 1 shows a group page 10 having an index of the components 12, 14, 16, 18, 20, 22, 24 of the family website system. Each link may include a description in addition to a link to a corresponding interrelated web page 12, 14, 16, 18, 20, 22, 24 within the family website system. Additionally, a number of links to websites 100 that are not part of the family website system may be presented thereon. The family homepage 10 may have a formatted background 30 to display one or more family photographs alone or in combination, for example, with a display of a tree 32 as shown in FIG. 1.

The group page 10 provides links to the various web pages and features described with respect to FIGS. 2-11 and may also provide a “What's New” link 34 that provides a link to webpages that may have been recently changed and/or updated. In addition, if photos have been added to a particular page, thumbnail replicas 36 of such photos or other such multimedia additions, may be provided on the group page 10 with a visual link thereto.

It is also contemplated that various recent messages, urgent news, reminders, upcoming events and the like may also be displayed on the group page 10. Such features are discussed in more detail with respect to the particular sub-group page displaying such features.

FIG. 2 shows a sub-group page 12 for a family unit that is a part of the family tree. For example, a husband and wife may share such a sub-group page 12, and each may personalize their respective portions 50, 52 of the page. The sub-group page 12 may include any number of the links 54 that were displayed on the group page 10. However, the sub-group page 12 may also contain photographs 56 and/or information relating to the particular members of the family unit and/or sub-group to which the page is dedicated. Additionally, each sub-group page 12 may relate to a personal web page 14, wherein each member of the sub-group may have their own personal webpage 14 that is linked therefrom.

As shown in FIG. 3, the personal page 14 may be individually organized and designed as a virtual photo book. This page may contain basic information 40 and photos 42 of their activities and such. The personality of each individual may be reflected by a choice of backgrounds 44, colors, layouts, styles and such. The individual member whose page it is, has the ability to administrate this page and make changes thereto. Additionally, the personal page 14 may contain deeper links such as to a resume page 46 relating to the individual to whom the personal page pertains. A particular contemplated use of the resume page 46, would be to allow family members to easily locate and print out the resume page of family members and provide copies thereof to prospective employers. The page, such as the resume page 46, may be formatted to be easily printed in a standard print resume format to increase the ease of use and effectiveness of this feature.

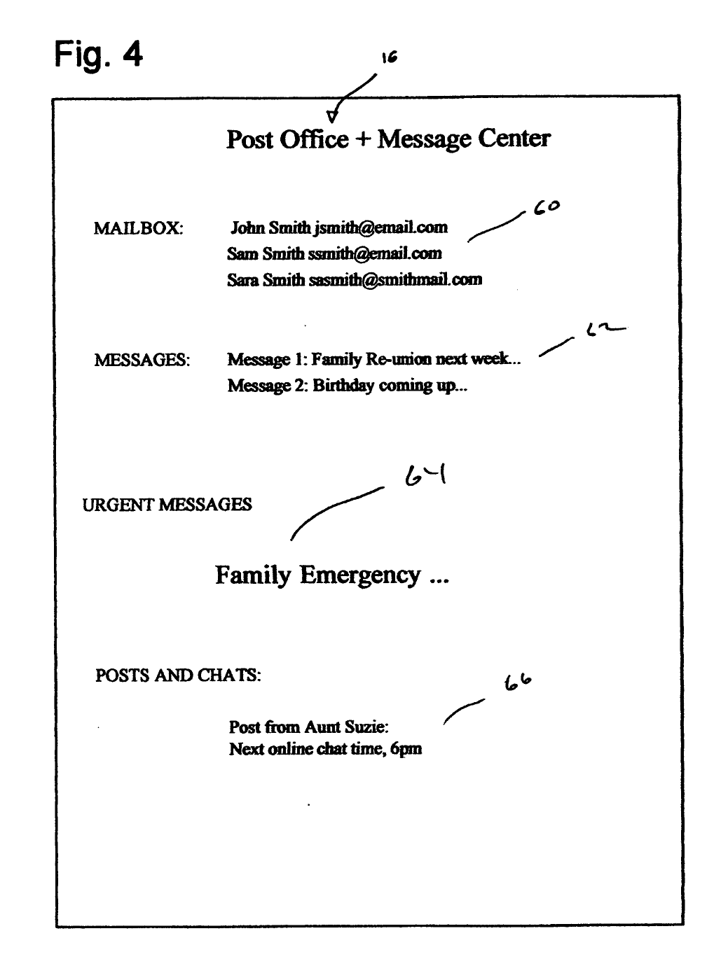

As shown in FIG. 4, a family post-office and message center page 16 may be yet another sub-group page. Family members may post their email address 60 and a message 62 posted to the family post-office 16 will be sent to all family members that have subscribed their email address to the message center 16. The message center 16 can be used to alert and notify family members of family news and events, such as an upcoming wedding, birth of a child, funeral and so on. This page may also contain contact information of the various members of the family, such as mailing addresses and telephone numbers. An option would exist for demarking urgent messages 64 in a bold or colored font and to be placed at a prominent position on the page. Messages sent to the message center 16 may also be automatically posted to the message center webpage 16 for viewing online.

The family post-office 16 may also have instant messaging 66 capability on this or another page allowing family members to chat online with one another.

The message center 16 may be in the form of a group email wherein by sending an email to that address, all members of the family website system will receive the message in their email inbox. There may also be a discussion board wherein the message is posted to a discussion page. Such discussion boards may be posted periodically, or may be posted in real time, such as in the form of a chat room.

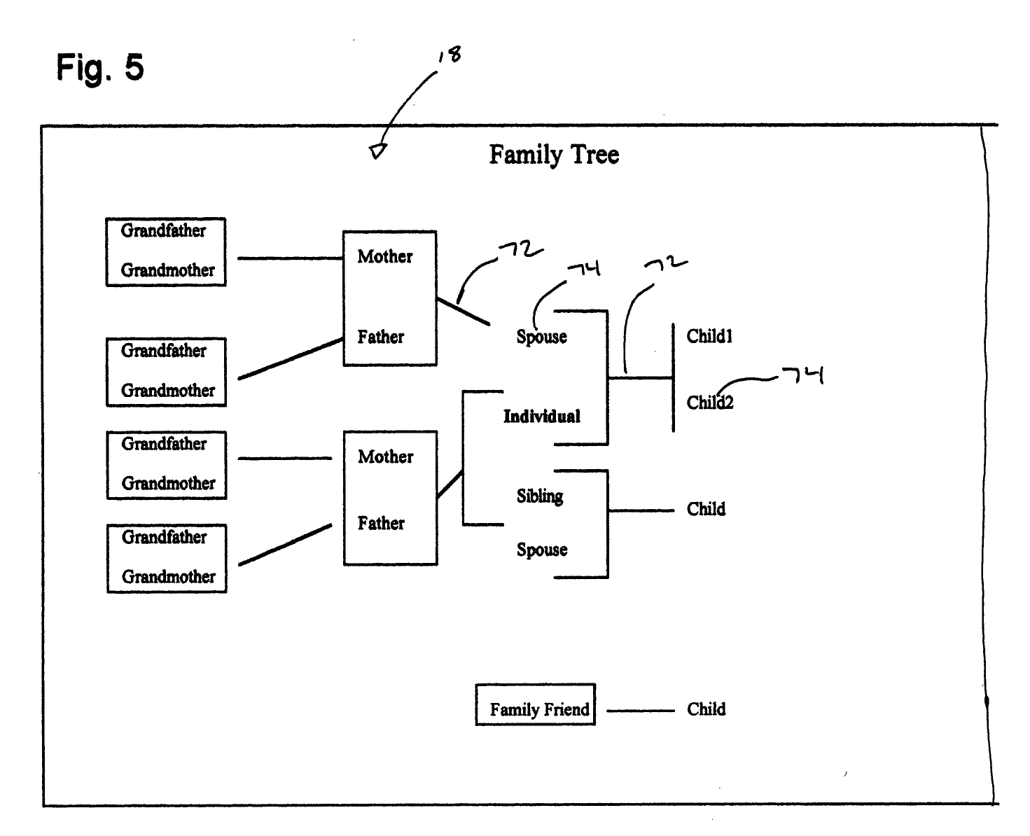

FIG. 5 shows a family tree sub-group page 18, dynamically displayable by a user such that the user's name 70 will be centered in the diagram 18, and the family relations extending therefrom are illustrated on the family tree diagram. The diagram may date as far back as desired or as far back as information is available. Each branch 72 of the family tree can have a name 74 of a family member and may include additional information such as date of birth, death, etc. Roots of ancestral lineage may also be listed. The family member name 74 may be linked to a personal page 14 and/or to a sub-group page 12, or a pair of links may be presented, one to the sub-group page 12 and one to the personal page 14. The names 74 may be formatted to differentiate male from female such as by color or style or background, etc. The names 74 may include additional information relating to health and medical history of a particular family member shown on the family tree diagram 18.

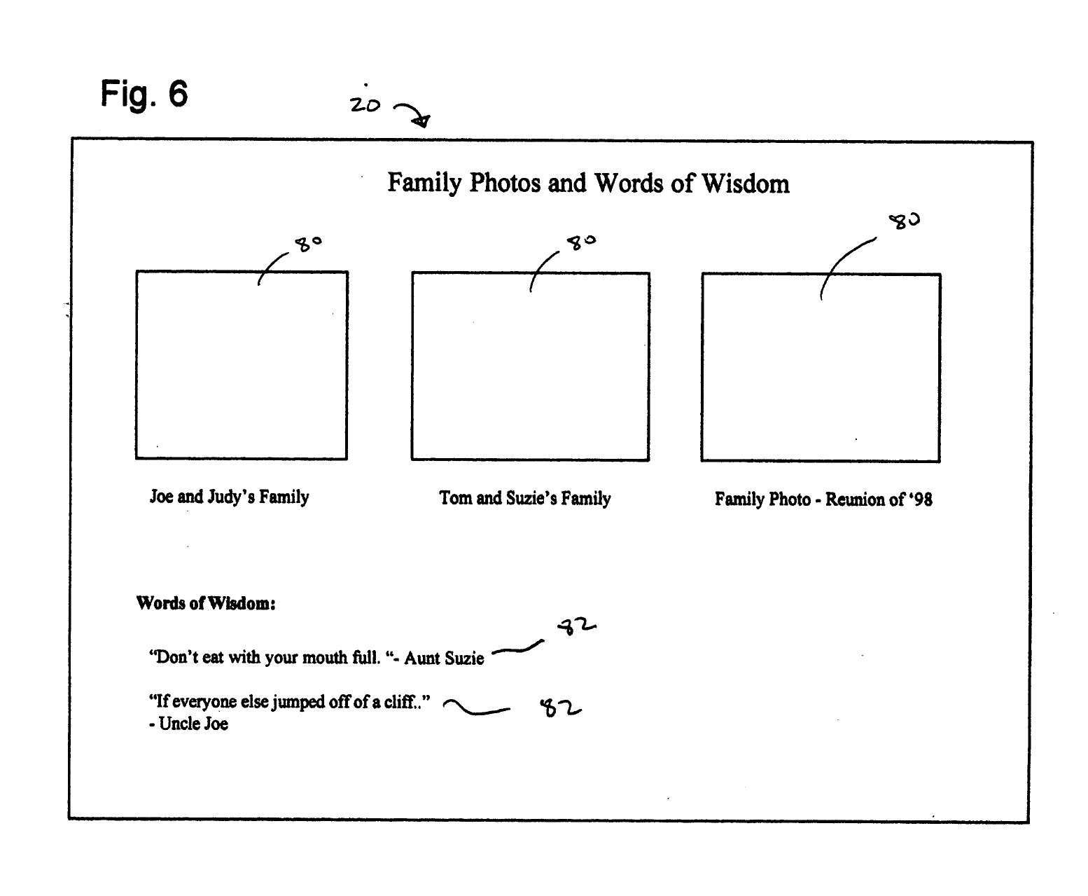

As shown in FIG. 6, a family photo page 20 may be set up for each family or for the entire group. For example, such pages may contain photos 80 from old reunions, weddings and other such events. New photos 80 may be added by users having access to the various sub-group pages. The sub-group pages may include a page or pages devoted solely to photographs 80, regardless of whether such photographs come from a particular family unit in the family tree.

Audio and video files (not shown) may likewise be uploaded to the various sub-group and personal pages in order to allow a visitor to view and hear multimedia representations of the various family members.

A words of wisdom page 20 may be yet another sub-group page where family members can post personal beliefs, credos, quotes and ideas. Such words of wisdom 82 may be posted in textual format, audio, video or any other such multimedia. In the embodiment shown in FIG. 6, the words of wisdom 82 are included on the family photo webpage 20, such that both the family photos 80 and words of wisdom 82 comprise a single sub-group page 20. A number of additional photo pages 20 may be included as the number of photos 80 does not allow for photos to be displayed on a single page. Likewise, a number of photo pages 20 may be organized in accordance with various sub-groups, such as single family units, a nuclear family photo album and the like. Words of wisdom 82 may be organized in a similar manner, either separately or in conjunction with corresponding photos.

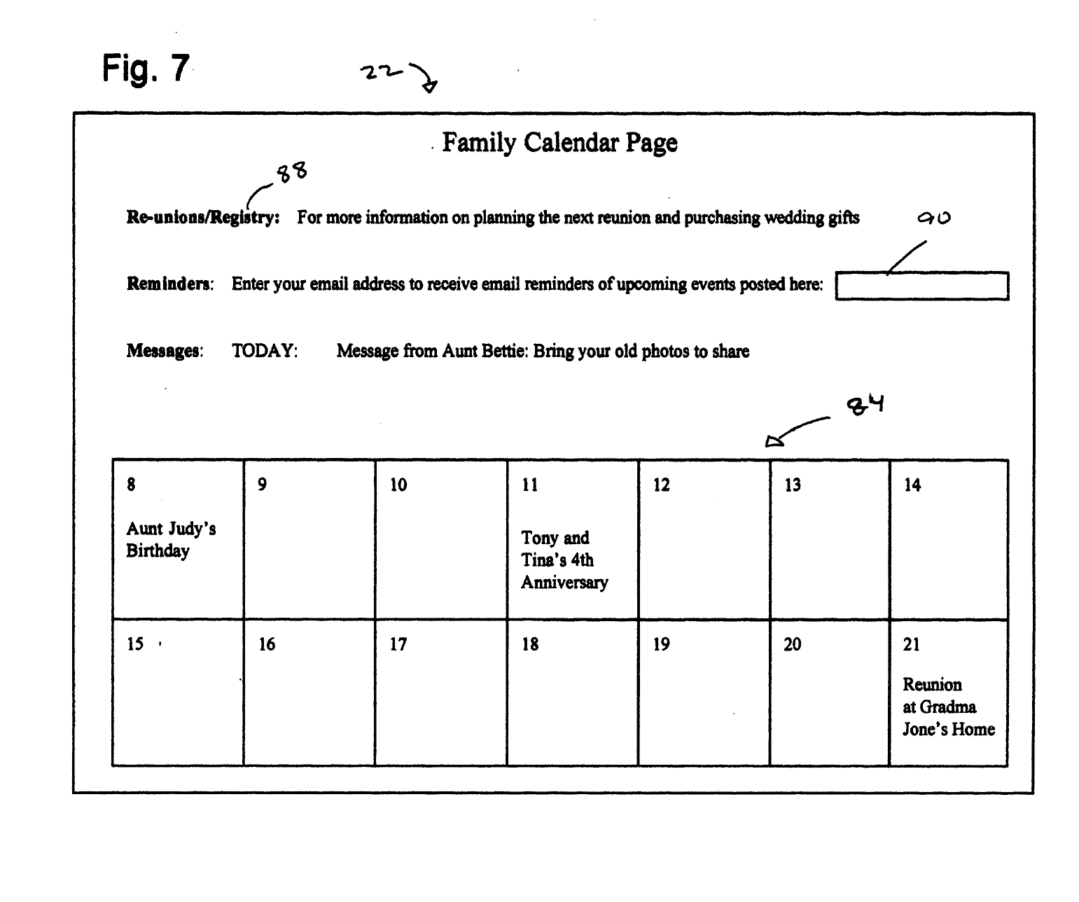

Another feature of the family website system is the virtual birthday and holiday calendar sub-group page 22, shown in FIG. 7. This would be a sub-group page 22 displayed with a calendar 84 that would list the birthdays, anniversaries and other important events relating to family members. Holidays and family events may also be added to the calendar page 22. This page 22 may contain links 88 to other websites for online retail companies such as florists and greeting cards to allow family members to easily purchase gifts for upcoming events. There also may be a do-it-yourself card making capability for users. The calendar 84 may formatted as desired such as daily, monthly, weekly or biweekly views. The calendar 84 is automatically rotated to show the current time frame.

Yet another feature of the present invention is a sub-group page having a registry 88 such as for bridal and baby showers, also shown in FIG. 7. This page would include information linking to stores and websites at which a family member has registered for gifts. Such page may also include links 88 to other websites relating to travel and lodging for an upcoming family reunion or event. As shown, the calendar page includes both the registry and reunion information links 88.

The calendar page 22 may additionally contain recent messages 62 from the message center page 16, and may allow users to enter their email address in a reminder section 90 to receive email reminders of upcoming family events that are posted to the calendar 84. Users may interact with the calendar 84 to add and/or remove new events on the calendar 84.

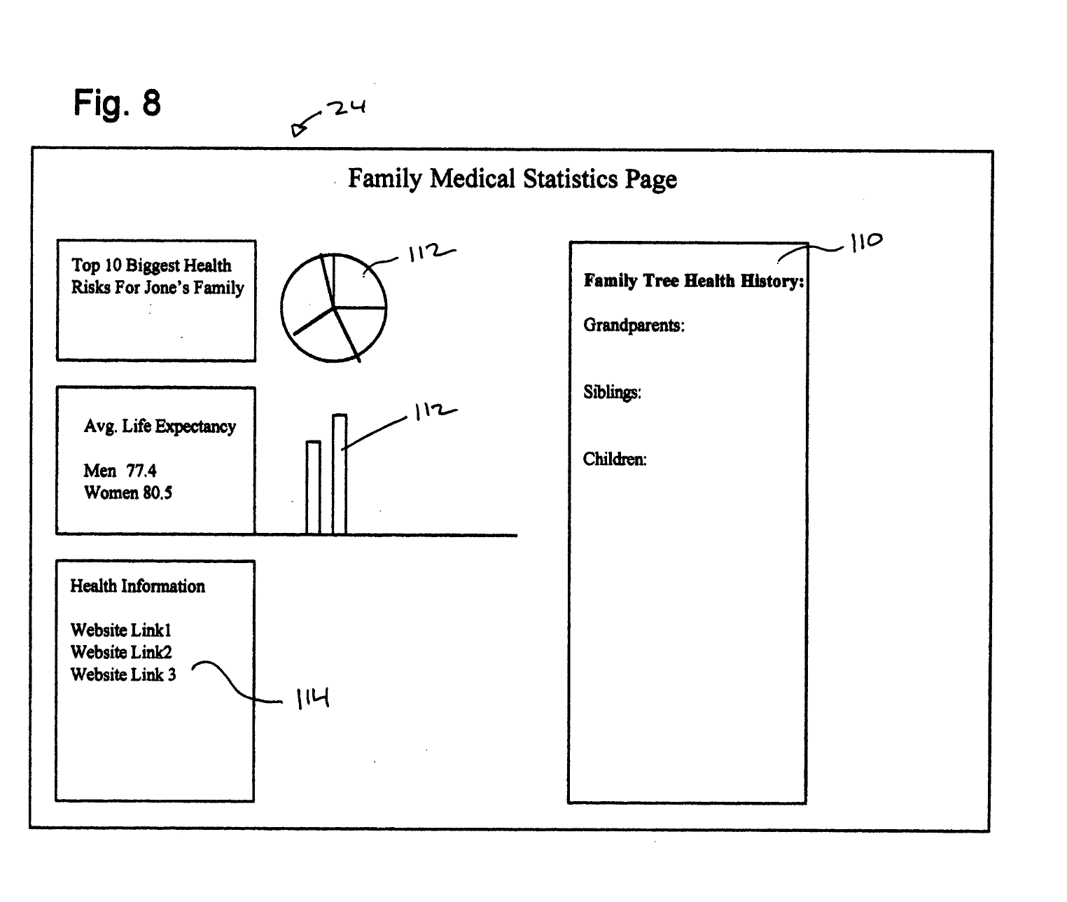

As shown in FIG. 8, a medical statistics page 24 may be yet another sub-group page. The documentation of the medical history and statistics of a family would allow for optimization of the care and decision making process for family members. This page 24 may include a family tree chart 110 with different symbols for ailments and diseases and/or color codes representing age at death for individual members of a family. A graphical display 112 may indicate the top ten biggest health hazards for a particular family, and may be updated as new information is collected.

Information relating to particular ailments and conditions of family members, and treatments that are being utilized may also be presented on this page or via links 114 to related websites to provide education and allowing family members to make informed healthcare decisions.

More detailed medical history information for particular family members may be presented on pages that are linked to from the medical history webpage 24. For example, a link relating to one grandparent may contain an entire web page detailing that grandparents health history and current medications and such.

The medical statistics information would be password protected, and access allowed only to those members that possess the password and properly enter it prior to viewing the medical statistics page 24.

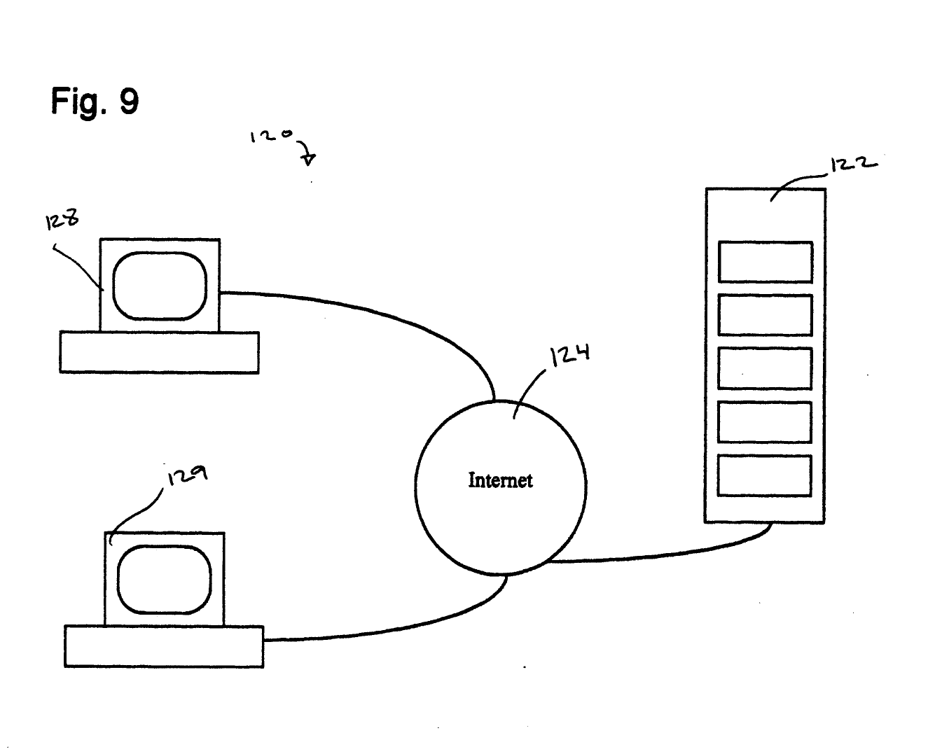

The family website system may be hosted by a third party server 122, as shown in FIG. 9. A family website system 120 is initiated by a founder, who will generally be a family member. The founder must register with the third-party such as by accessing an administrative registration page, entering registration information and making a payment, or by uploading a program, such as from a CD-ROM and filling out the necessary information.

Once the family website has been founded, it will be accessible over the internet 124, but most likely password protected. Family members will be able to administer various portions of the family website. Each family member may have a different password for administration of different pages of the website.

FIG. 10 illustrates an example of an administrative webpage 28 for making changes to a webpage within the family website system. An administrative page 28, accessible by family members, will allow family members to create a group page 10 with links and information relating to the various family members, sub-group pages relating to the different family units and the different features of the family website, and the personal pages.

The web pages of the family website system may be entirely or partially protected by a password, for example preventing access to certain webpages or all webpages unless a visitor is able to correctly enter a password. Files may be added to different webpages by accessing the file upload section 170 of the administration page. Files may be uploaded to a predetermined page in accordance with permissions allowed in a directory 172. The layout may be controlled by a layout section 174, and the administrator may determine whether the page will be password protected by selecting a protection status 176.

Each family member may have a customizable homepage 26, an example of which is shown in FIG. 11, for use with the family website system. The homepage 26 may be set to be automatically displayed when the user accesses the internet. The homepage 26 may be customized to contain one or more features or portions of such features of the family website system, as discussed with reference to FIG. 1-9.

The customized homepage 26 may contain a listing of the various sub-groups 12, 14, 16, 18, 20, 22, 24 of the family website system. Such a listing may include hyperlinks to other sub-group pages and/or personal pages 14.

A portion of the homepage 26 may have a notification section 34 that is updated when any changes to other pages in the website have been made. For example, if a photograph 42 was added to a personal webpage 14, a thumbnail 36 of that photograph 42 may be displayed in the notification section 34, and/or the web URL address may merely be listed with a hyperlink thereto. Such notification section 34 may also be present on other pages, such as the group webpage 10.

The homepage 26 may also be personalized to include links 140 to other websites that are not a part of the virtual family website system in accordance with the interests of the particular user, including stocks, news and sports websites, for example.

The message center 16 may also be at least partially displayed and accessed from the homepage 26. The homepage 26 may be configured to display recent messages 62, posts and chats and news of any upcoming chats and a link to archives of such messages.

A portion of the family calendar 84 may also be displayed and accessed on the homepage 26. For example, future family events may be entered onto the calendar 84 and information relating to those events may be displayed on the homepage 26.

It is understood that the use of an interactive calendar, discussion board, email group, and chat room allows that such features be administrated by separate administrative webpages, and a separate webpage may be created that is primarily focused on one of the above particular functions.

Discussion shall now address the system 120 used to administrate and create the family website system, as illustrated in FIG. 9. A server 122 is connected to the internet 124 allowing potential users of the family website system to access the administrative page of the family website system from the server 122. An administrator registers with the server to allow access and technical support and to allow changes and improvements to be made.

The server allows users to store photos, videos, audio and textual information that is displayed and organized on the virtual family website system. For example, the server is programmed to ensure that specific photos and videos are associated with the corresponding web page that they are intended for. Also, located on the server are the different layouts and formats that can be chosen and/or created by the users, such that different pages may have different themes and so on.

The server additionally contains the sub-group web page information which may be updated to display current changes to the website.

As shown, a single person or a number of people can upload information and files to the server to be displayed on predetermined web pages within the family website, so long as such persons are able to access the server and provide the proper password identification.

Each page or any group or sub-group of pages may be separately accessible by one or more members of the group by a unique and different password based upon the particular authorization of each user.

Access may be determined by the server, or by the administrator and/or founder of the family virtual tree. Family members may then access the family website system remotely in accordance with the permissions granted by the administrator, and/or the instructions given to the server. The remote computer 128 accesses the server, such as over the internet and is able to upload/change and view the various pages of the website. Once uploaded, the website is viewable on any other remote computer 129, although various pages of the website may require a password in order for the remote computer to display such a website page.

It is understood that the description of the present invention contained herein is merely illustrative, and that it is contemplated that many combinations of the features and interrelated webpages described herein may be utilized, which fall within the scope of the present invention.

1. A virtual family website system comprising:
an index webpage displaying information relating to a group of people;
a secondary webpage displaying information relating to a sub-group of the group of people, said index webpage having a hyperlink to said secondary webpage;
a personal webpage displaying information relating to a member of the sub-group, said index webpage being capable of displaying a notification of changes to said personal webpage.

2. The virtual family website system according to claim 1 wherein said secondary webpage includes information relating to the medical history of the group of people.

3. The virtual family website system according to claim 1 wherein said secondary webpage includes a message center allowing the group of people to view messages.

4. The virtual family website system according to claim 1 wherein said secondary webpage includes a calendar of events relating to the group of people.

5. The virtual family website system according to claim 1 wherein the personal webpage is customizable by the member.

6. The virtual family website system according to claim 5 further comprising a medical history page, said group page having a hyperlink to said medical history page.

7. The virtual family website system according to claim 6 further comprising an urgent news page, said group page having a hyperlink to said urgent news page.

8. The virtual family website system according to claim 7 further comprising a reminders webpage, said group page having a hyperlink to said reminders webpage.

9. The virtual family website system according to claim 8 further comprising a homepage, said homepage having a hyperlink to said calendar webpage and a hyperlink to said message center page, said homepage capable of displaying a notification of changes to the family website system.

10. A webpage system for storing and displaying data relating to a group of people, said system comprising:
a) a remote computer;
b) a server for receiving instructions from said remote computer and displaying a sub-group webpage in accordance with the instructions received from said remote computer;
c) a group webpage displayable by said server and viewable by said remote computer, said group webpage capable of displaying a notification that changes have been made to said sub-group webpage.

11. The webpage system according to claim 10 wherein said server is capable of displaying a personal webpage in accordance with the instructions received from said remote computer.

12. The webpage system according to claim 11 wherein said server is capable of displaying a homepage containing selected information from said group webpage and said sub-group webpage and said personal webpage.

13. The webpage system according to claim 12 wherein said server is capable of displaying on said homepage a notification of changes made to said webpage system.

14. A method for creating a family website system, said method comprising the steps of:
a) setting up a parent webpage having a number of hyperlinks to child family webpages, said child family webpages capable of having a hyperlink to a personal web page
d) uploading a digital photograph to said personal webpage
e) displaying a notification on said family webpage that said digital photograph has been added to said personal webpage.

15. The method according to claim 14 further comprising:
uploading and displaying photographs to a photo album webpage.

16. The method according to claim 15 further comprising:
uploading and displaying a reunion webpage.

17. The method according to claim 16 further comprising:
uploading and displaying a registry webpage.

18. The method according to claim 17 further comprising:
uploading and displaying a family tree diagram for display on a family tree webpage.

19. The method according to claim 18 further comprising:
uploading and displaying words of wisdom for display on a words of wisdom webpage.

20. The method according to claim 19 further comprising:
uploading and displaying a resume webpage for viewing by a remote computer.
